(19) United States
(12) Patent Application Publication
(10) Pub. No.: US 2009/0327884 A1
(43) Pub. Date: Dec. 31, 2009

(54) COMMUNICATING INFORMATION FROM AUXILIARY DEVICE

(75) Inventors: Gregory Parks, Redmond, WA (US); Andrew Fuller, Redmond, WA (US); Mohamed Belali, Issaquah, WA (US); Daniel Jacob Polivy, Seattle, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/145,512

(22) Filed: Jun. 25, 2008

(51) Int. Cl. G06F 3/048

(52) U.S. Cl. 715/700

(57) ABSTRACT

An auxiliary device communicates with a user in a manner other than a conventional, textual visual representation. For example, auxiliary device(s) can provide information aurally, vocally, visually (non-textual), tactilely and/or olfactorily. The information communicated can include alternative information to information displayed on a primary display of the computer system. A platform component of a computer system can provide device-specific and/or device-independent information to the auxiliary device.

### BACKGROUND

The wide spread use of the Internet has increased the amount of information available to a user. It has become increasingly difficult and frustrating for user(s) to manage the available information.

Frequently, user(s) can have a need to be aware of certain type(s) of information without drawing attention specifically to the information. For example, it can be useful for information regarding particular stocks to be continually updated and passively available to a user. In this manner, when the user desires to review the information, the information is readily available to the user without any action by the user.

Auxiliary display system(s) have been designed to take information available to a computer system (e.g., from within the computer system and/or available from a network attached to the computer system), and make that information available to an auxiliary device. The auxiliary device typically renders that information on a display separate from a primary display used by the computer system for the display of information. This separate display can include displays integrated into the computer enclosure and/or attached to the computer system (e.g., wired and/or wireless communication). The auxiliary device optionally includes a means by which a user can navigate and control which and how much information is presented on the device at any one time. This navigation capability usually includes simple directional buttons or such buttons represented as targets on a touch display.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

The disclosed architecture facilitates communication of information via an auxiliary device that communicates with a user in a manner other than a conventional, textual visual representation. For example, auxiliary device(s) can provide information aurally, vocally, visually (non-textual), tactilely and/or olfactorily.

A computer-implemented auxiliary device system includes an auxiliary device that includes an input component that receives semantic content from the computer system. The auxiliary device further includes an output component that communicates information to a user in a manner other than a conventional, textual visual representation based on the semantic content. The information communicated can include alternative information to information displayed on a primary display of the computer system.

Optionally, the auxiliary device can include a format component that formats the semantic content for communication to the user. For example, the format component can format the semantic content to provide output to a user via the auxiliary device and/or via another additional device. Further, the format component can format navigation and/or control inputs received from the user into semantic content that is output to the computer system.

The computer-implemented auxiliary device system can, optionally, include a computer system that provides semantic content, for example, from a specialized application that communicates via a platform component. In one embodiment, the platform component provides device-specific information to the auxiliary device. In this embodiment, the platform component is aware of the capabilities of the auxiliary device and provides information to the auxiliary device in a format expected by the auxiliary device. Further, the platform component can filter the information based upon the capabilities of the auxiliary device.

In another embodiment, the platform component provides device-independent information to the auxiliary device. The auxiliary device processes the information received from the platform component and then communicates information to a user. The auxiliary device can filter the information received from the platform component based, for example, upon capabilities of the device, hours of operation and/or user preference(s).

Optionally, the auxiliary display device can send information back to the computer system, in particular, user navigation information. For example, with an aural auxiliary device, when reading email to a user, the user could say “next”, “back”, “open” etc. in order to navigate a structure of emails. These navigation event(s) can be passed back to the computer system as semantic content to be processed and/or processed locally on the auxiliary device.

To the accomplishment of the foregoing and related ends, certain illustrative aspects are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

FIG. 1 illustrates a computer-implemented auxiliary device system.

FIG. 2 illustrates a computer-implemented system facilitating communication via an auxiliary device.

FIG. 3 illustrates a computer-implemented method of communicating with an auxiliary device.

FIG. 4 illustrates a computer-implemented method of providing non-textual information to a user.

FIG. 5 illustrates a computing system operable to execute the disclosed architecture.

FIG. 6 illustrates an exemplary computing environment.

### DETAILED DESCRIPTION

The disclosed architecture facilitates communication of information via an auxiliary device that provides information to a user in a manner other than a conventional, textual visual representation. For example, auxiliary device(s) can provide information aurally, vocally, visually (non-textual), tactilely and/or olfactorily. Responses by the user in a form specific to the auxiliary device can be converted to semantic content that can navigate and control which information is shown on the device at what time.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well-known structures and devices are shown in block diagram form in order to facilitate a description thereof.

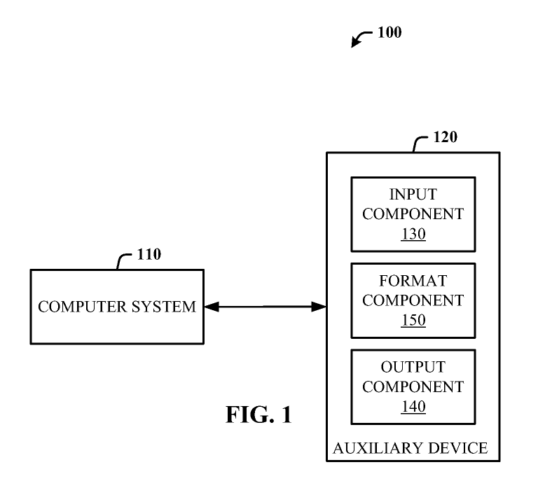

Referring initially to the drawings, FIG. 1 illustrates a computer-implemented auxiliary device system 100. The system 100 includes a computer system 110 that provides semantic content (e.g., content that has information associated with the content) to an auxiliary device 120. The auxiliary device 120 communicates the semantic content to a user, as discussed below.

Auxiliary displays conventionally render information on a display separate from a primary display used by the computer system for the display of information. This information is displayed visually; however, the visual display can be limiting. Textual information generally is interacted with in a particular way—that is a user reads the text in order to comprehend the communicated information. Reading text can be difficult when a user is focused on other task(s) such as driving or viewing a movie in a darkened theater. Further, it can be difficult to interact with an auxiliary display if the display is not visible, for example, when a laptop or phone is in a user's briefcase.

Additionally, textual information is generally not encoded and can be viewed by other(s) near the auxiliary device. Thus, confidential and/or sensitive information cannot generally be securely displayed.

The auxiliary device 120 includes an input component 130 that receives semantic content from the computer system 100. The auxiliary device 120 further includes an output component 140 that communicates information to a user based on the semantic content in a manner other than a conventional, textual visual representation. The information communicated can include alternative information to information displayed on a primary display of the computer system. For example, while a primary display is displaying information associated with a user's work environment, the auxiliary device 120 can communicate information to the user regarding the user's personal environment (e.g., presence of email in personal email account) and/or supplemental information.

Further, in one example, the auxiliary device 120 can be a sole device with which a user is interacting at a particular time. For example, the auxiliary device 120 can communicate with a user while a cover of a notebook computer is closed but still running. In this manner, the user can continue to receive information without viewing the primary display. Additionally, in one example, the auxiliary device 120 can cache semantic content received from the computer system 110. In this manner, the auxiliary device 120 can communicate non-textual information based on the received semantic content even after disconnection from the computer system 110. The auxiliary device 120 can also communicate non-textual information based on semantic content received by integration with other components internal to the computer system 110. For example, the auxiliary device 120 can receive information from the computer system 110 indicating that a battery of the computer system 110 is low. The computer system 110 can hibernate and/or shutdown, while the auxiliary device 110 communicates non-textual information based on the received information indicating that the battery was low.

In one embodiment, the auxiliary device 120 can be implemented as a separate computing subsystem within an enclosure of the computer system 110 (e.g., mobile and/or desktop), attached to a computer system 110 by a wired or wireless communications transport and/or network interface, a separate computing subsystem external to an enclosure of the computer system 110 (e.g., with wired and/or wireless communication with the computer system 110); and/or, a separate computing subsystem in a way that can be either internal (docked) or external to an enclosure of the computer system 110 coupled to the computer system 110 by a wired, wireless communications transport and/or network interface.

Further, at least a portion of the auxiliary device 120 can be implemented within the computer system 110 with presentation facitility(ies) internal and/or external to the computer system 110.

In one embodiment, the auxiliary device 120 provides information to a user aurally. In one example, the auxiliary device 120 can generate one or more tones based on the semantic content received from the computer system 110. In another example, the auxiliary device 120 can play a tune based on the semantic content received from the computer system 110. In this example, the tune can be a theme that serves as personal encoding for the received semantic content. In another example, the auxiliary device 120 can generate polyphonic tones (e.g., multiple simultaneous tones) based on the semantic content received from the computer system 110.

In yet another example, the auxiliary device 120 can generate “music” encoded to represent the received semantic content (e.g., harmonious vs. discordant, changes in rhythm and/or meter, pitch, etc.). The generated encoded “music” is meaningful to the user. Further, the auxiliary device 120 can produce combinations of natural sounds and/or volumes (e.g., birds chirping, thunder, rain, trees rustling, monkeys howling, etc.) based on the received semantic content.

Finally, the auxiliary device 120 can provide semantic content aurally via mechanical actuation of one or more sound generating devices. For example, the auxiliary device 120 can actuate one or more bells, pulled cat tail organ, and the like.

The auxiliary device 120 can further provide information to a user vocally. For example, the auxiliary device 120 can generate speech pattern(s) based, at least in part, upon the semantic content received from the computer system 100.

In one embodiment, the auxiliary device 120 can provide information to a user visually. The auxiliary device 120 can activate a particular glowing color, a blinking frequency of a light, a blinking pattern of a light, a blinking light with a varying frequency or duty cycle, a light blinking with an encoded pattern, activate one or more lights (e.g., light emitting diodes (LEDs), light bulbs, etc.) and the like, based, at least in part, upon the semantic content received from the computer system 100.

In one example, an auxiliary device 120 can include four LEDs and selectively activate a first LED when email is received from a user's work superior, a second LED when email is received from the user's spouse, a third LED when a telephone call has been received, and, the fourth LED when rain is predicted to occur.

In another example, meaningful visual pattern(s) (e.g., icon(s) and/or a series of icons) can be displayed by the auxiliary device 120 based on the received semantic content. In another example, an image (e.g., a well-known image such as the Mona Lisa) can be modified (e.g., smile changes, eyebrows change, etc.) based on the received semantic content.

In yet another example, the auxiliary device 120 can visually display abstract encoding using received semantic content as a seed, for example, a fractal and/or virtual tree. Further, the auxiliary device 120 can employ an abstract pattern that can grow in an encoded way based on the received semantic content. For example, a tree growing additional branches, representing different people, and leaves growing on those branches to indicate number of messages from that person.

In yet another example, the auxiliary device 120 can visually display one or more fixed pattern(s) that are filled-in (e.g., like a coloring book) and/or grow within the dimensions of a fixed pattern (e.g., a long, curved spiral that gets brighter along its length with the overall pattern unchanged) based on the received semantic content. Further, based on the received semantic content, encoded symbol(s) can be displayed by the auxiliary device 120 (e.g., encoded custom character set(s)).

Additionally, the auxiliary device 120 can visually present information based on the received semantic content without a display. For example, the auxiliary device 120 can provide the received semantic content through the length of one or more cords, rotation of a wheel, angle of an arm adjusted mechanically, and the like.

Continuing, the auxiliary device 120 can further provide information to a user tactilely, for example, based on frequency vibrations, an inaudible mechanical vibration, pin-like array pattern(s), Braille raised dots, temperature, an exerted variable force, an electrical stimulus, a static electrical charge (e.g., hair standing on end), inflating of a balloon or other bladder, liquid filling a vessel, liquid being expelled from a vessel by gas pressure, and the like. For example, the auxiliary device 120 can provide a Braille raised dot pattern for “Y” when email is present in the user's email account. In another example, the auxiliary device 120 can provide information based on vibration (e.g., one buzz for an email from a superior, two buzzes for an email from a spouse, etc.).

In one embodiment, the auxiliary device 120 can provide information to a user olfactorily (e.g., based on the sense of smell). For example, the auxiliary device 120 can release a particular scent (e.g., a spouse's cologne) when an email is received from a particular sender.

Optionally, the auxiliary device 120 can include a format component 150 that formats the semantic content for communication to the user. For example, the format component 150 can format the semantic content to provide output to a user via the auxiliary device 120 and/or via another additional device.

The auxiliary device 120 can, for example, provide information to one or more additional devices. In this example, the auxiliary device 120 does not directly provide information to a user but translates and/or formats the information for use by the additional device(s). For example, the auxiliary device 120 can transcode the information into short message service (SMS) format, multimedia message service (MMS) format, streaming content, email format, etc. With MMS format, for example, the auxiliary device 120 can transcode the received semantic content into a still image, a movie and/or an audio recording.

Optionally, the auxiliary device 120 can send information back to the computer system 11 0, for example, user navigation information and/or external data collected by the auxiliary device 120 (e.g., provided to the computer system 110 for processing, for example, to determine presence of a user based on sound level). For example, with an aural auxiliary device 120, when reading email to a user, the user could say “next”, “back”, “open” etc. in order to navigate a structure of emails. These navigation events can be formatted by the format component to be passed back to the computer system 110 as semantic content to be processed and/or processed locally on the auxiliary device 120. For example, navigation semantic content can be provided from the auxiliary device 120 to the computer system 110 in a uniform way without regard to a mechanism associated with navigation input (e.g., voice, joystick, sounds, vigorous shaking, directional pad, etc.).

The auxiliary device 120 can include, for example navigation button(s) (e.g., physical button(s) and/or touch-sensitive virtual button(s)), track-pad and/or stylus gestures. In one embodiment, the information sent from the auxiliary device 120 can be based on audio information such as:
Vocal commands
Pitch commands from generated sounds (for example, humming, singing, playing a single-note instrument, playing a polyphonic note instrument, etc.)
Modulated sounds, with meaning determined by length (e.g., short vs. long sounds)
Combinations of pitch and duration
Finger snaps, surface taps (e.g., not on display and/or buttons but, for example, on a hard surface such as a table)
Tooth clicks
Tongue clicks
Whistles
Hand claps
Lip smacks and puffs

In one embodiment, the information sent from the auxiliary device 120 can be based on haptic (e.g., various forms of physical touch), motion and/or gesture information such as:
Directional shaking and/or tilting (e.g., sharp roll or pitch and yaw or linear accelerations to indicate direction, paging, etc.)
Physical motions detected by accelerometer(s) attached to limbs rather than to the device itself (e.g., wave arm/leg and hand/foot, up, wave down, left, right, etc.)
Finger motions or hand motions detected by accelerometer(s)
Head motions detected by accelerometer(s)
Foot taps detected by accelerometer(s)
Hand motions (hand gestures)
Tongue motions (e.g., detect user's tongue in the quadrants of user's lips)
Tooth clicks
Tongue clicks
Eye blinks, eyebrow motions
Facial expressions
Eye motions
Jaw motions and positions
Individual tooth/tongue contacts

In one embodiment, the information sent from the auxiliary device 120 can be based on optical information, for example,
Finger and limb motions as detected optically
Optical recognition of American Sign Language
Light flashes, varying color, duration, duty cycle

In one embodiment, the information sent from the auxiliary device 120 can be based on electrical information
EEG and other neural-electrical signals
Electrical sensing of muscle movements
Galvanic skin response

In one embodiment, the information sent from the auxiliary device 120 can be based on information received from a remote hardware device. For example, information can be received from a physical device separate from the auxiliary device 120 that does the above and transmits (e.g., wirelessly and/or wired) the interaction information to the auxiliary device 120 for translation to semantic content for the computing system 110 or used on the auxiliary device 120 itself.

While information sent from the auxiliary device 120 to the computer system 110 has been described in the context of control and/or navigation, those skilled in the art will recognize that any suitable information can be encoded as text by the auxiliary device 120 and provided to the computer system 110 (e.g., responding to emails, SMS, instant messages and the like).

Those skilled in the art will recognize that the computer system 110 can be any suitable computing system. For example, the computer system 110 can be a personal computer system, a personal digital assistant, a local server, a remote server and the like.

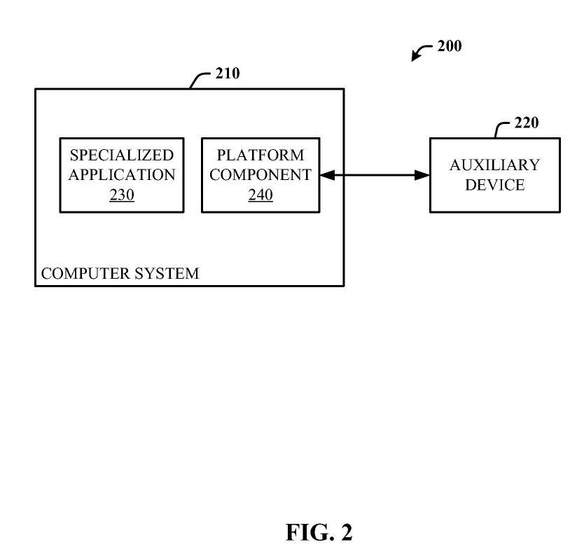

FIG. 2 illustrates a computer-implemented system 200 facilitating communication via an auxiliary device. The system 200 includes a computer system 210 and an auxiliary device 220. The computer system 210 includes a specialized application 230 and a platform component 240.

The specialized application 230 is an application that provides data from the computer system 210 to the auxiliary device 220 via the platform component 240. The specialized application 230 is independent of communication layer(s) provided by the platform component 240 to communicate with the auxiliary device 220. The specialized application 230 retrieves data from a data source (e.g., an application, a web service, etc.) and provides the data to the platform component 240.

The platform component 240 can communicate with the auxiliary device 220 via a wired and/or wireless connection. For example, the auxiliary device 220 can be connected to the computer 210 through a universal serial bus (USB) port, a Bluetooth® connection, and/or a transmission control protocol/Internet protocol connection (TCP/IP).

In one embodiment, the platform component 240 provides device-specific information to the auxiliary device 220. In this embodiment, the platform component 240 is aware of the capabilities of the auxiliary device 220 and provides information to the auxiliary device 220 in a format expected by the auxiliary device 220. Further, the platform component 240 can filter the information based upon the capabilities of the auxiliary device 220.

In another embodiment, the platform component 240 provides device-independent information to the auxiliary device 220. The auxiliary device 220 processes the information received from the platform component 240 and then communicates information to a user based on the information received from the platform component 240. The auxiliary device 220 can filter the information received from the platform component 240 based, for example, upon capabilities of the device and/or user preference(s).

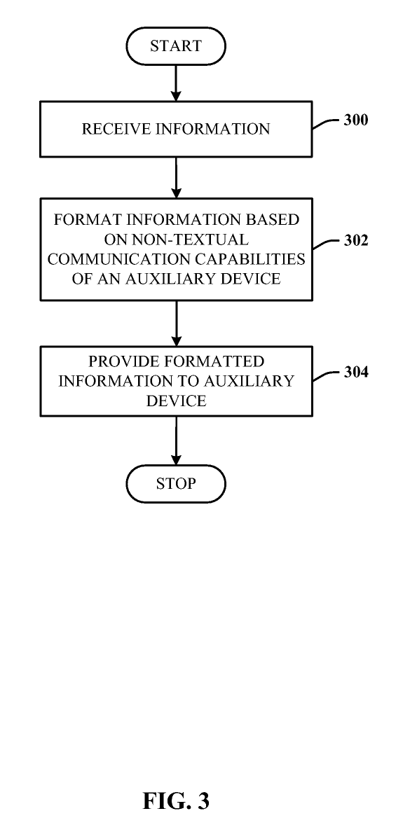

FIG. 3 illustrates a computer-implemented method of communicating with an auxiliary device. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

At 300, information is received, for example, from a specialized application. At 302, the information is formatted based on non-textual user communication capabilities of an auxiliary device. At 304, the formatted information is provided to the auxiliary device.

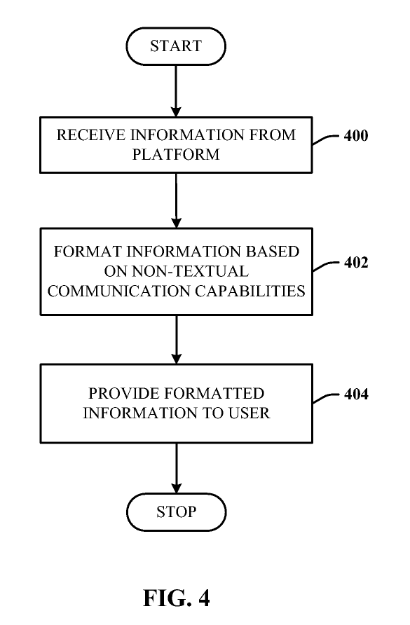

FIG. 4 illustrates a computer-implemented method of providing non textual information to a user. At 400, information is received from a platform component. At 402, the information is formatted based on non-textual communication capabilities of an auxiliary device. At 404, the auxiliary device provides the formatted information to the user.

As used in this application, the terms “component” and “system” are intended to refer to a computer-related entity, either hardware, a combination of hardware and software, software, or software in execution. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

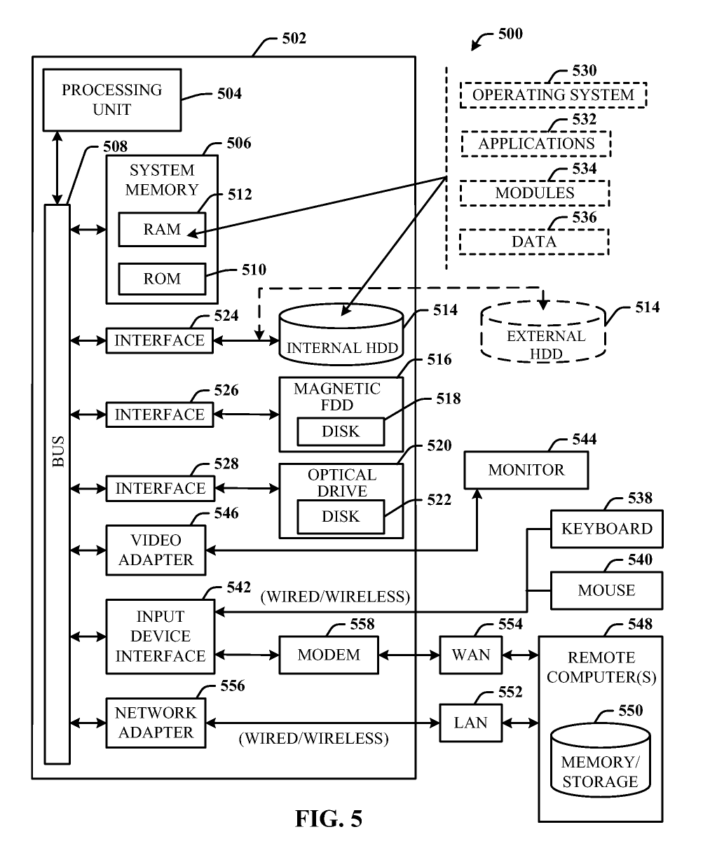

Referring now to FIG. 5, there is illustrated a block diagram of a computing system 500 operable to execute the disclosed architecture. In order to provide additional context for various aspects thereof, FIG. 5 and the following discussion are intended to provide a brief, general description of a suitable computing system 500 in which the various aspects can be implemented. While the description above is in the general context of computer-executable instructions that may run on one or more computers, those skilled in the art will recognize that a novel embodiment also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes volatile and non-volatile media, removable and non-removable media. By way of example, and not limitation, computer-readable media can comprise computer storage media. Computer storage media includes volatile and non-volatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital video disk (DVD) or other optical disk storage, magnetic cassettes, magnetic tape, magnetic disk storage or other magnetic storage devices, or any other medium which can be used to store the desired information and which can be accessed by the computer.

With reference again to FIG. 5, the exemplary computing system 500 for implementing various aspects includes a computer 502, the computer 502 including a processing unit 504, a system memory 506 and a system bus 508. The system bus 508 provides an interface for system components including, but not limited to, the system memory 506 to the processing unit 504. The processing unit 504 can be any of various commercially available processors. Dual microprocessors and other multi-processor architectures may also be employed as the processing unit 504.

The system bus 508 can be any of several types of bus structure that may further interconnect to a memory bus (with or without a memory controller), a peripheral bus, and a local bus using any of a variety of commercially available bus architectures. The system memory 506 includes read-only memory (ROM) 510 and random access memory (RAM) 512. A basic input/output system (BIOS) is stored in the read-only memory 510 such as ROM, EPROM, EEPROM, which BIOS contains the basic routines that help to transfer information between elements within the computer 502, such as during start-up. The RAM 512 can also include a high-speed RAM such as static RAM for caching data.

The computer 502 further includes an internal hard disk drive (HDD) 514 (e.g., EIDE, SATA), which internal hard disk drive 514 may also be configured for external use in a suitable chassis (not shown), a magnetic floppy disk drive (FDD) 516, (e.g., to read from or write to a removable diskette 518) and an optical disk drive 520, (e.g., reading a CD-ROM disk 522 or, to read from or write to other high capacity optical media such as the DVD). The internal hard disk drive 514, magnetic disk drive 516 and optical disk drive 520 can be connected to the system bus 508 by a hard disk drive interface 524, a magnetic disk drive interface 526 and an optical drive interface 528, respectively. The interface 524 for external drive implementations includes at least one or both of Universal Serial Bus (USB) and IEEE 1394 interface technologies.

The drives and their associated computer-readable media provide nonvolatile storage of data, data structures, computer-executable instructions, and so forth. For the computer 502, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing novel methods of the disclosed architecture.

A number of program modules can be stored in the drives and RAM 512, including an operating system 530, one or more application programs 532, other program modules 534 and program data 536. All or portions of the operating system, applications, modules, and/or data can also be cached in the RAM 512. It is to be appreciated that the disclosed architecture can be implemented with various commercially available operating systems or combinations of operating systems.

A user can enter commands and information into the computer 502 through one or more wired/wireless input devices, for example, a keyboard 538 and a pointing device, such as a mouse 540. Other input devices (not shown) may include a microphone, an IR remote control, a joystick, a game pad, a stylus pen, touch screen, or the like. These and other input devices are often connected to the processing unit 504 through an input device interface 542 that is coupled to the system bus 508, but can be connected by other interfaces, such as a parallel port, an IEEE 1394 serial port, a game port, a USB port, an IR interface, etc.

A monitor 544 or other type of display device is also connected to the system bus 508 via an interface, such as a video adapter 546. In addition to the monitor 544, a computer typically includes other peripheral output devices (not shown), such as speakers, printers, etc.

The computer 502 may operate in a networked environment using logical connections via wired and/or wireless communications to one or more remote computers, such as a remote computer(s) 548. The remote computer(s) 548 can be a workstation, a server computer, a router, a personal computer, portable computer, microprocessor-based entertainment appliance, a peer device or other common network node, and typically includes many or all of the elements described relative to the computer 502, although, for purposes of brevity, only a memory/storage device 550 is illustrated. The logical connections depicted include wired/wireless connectivity to a local area network (LAN) 552 and/or larger networks, for example, a wide area network (WAN) 554. Such LAN and WAN networking environments are commonplace in offices and companies, and facilitate enterprise-wide computer networks, such as intranets, all of which may connect to a global communications network, for example, the Internet.

When used in a LAN networking environment, the computer 502 is connected to the LAN 552 through a wired and/or wireless communication network interface or adapter 556. The adapter 556 may facilitate wired or wireless communication to the LAN 552, which may also include a wireless access point disposed thereon for communicating with the wireless adapter 556.

When used in a WAN networking environment, the computer 502 can include a modem 558, or is connected to a communications server on the WAN 554, or has other means for establishing communications over the WAN 554, such as by way of the Internet. The modem 558, which can be internal or external and a wired or wireless device, is connected to the system bus 508 via the serial port interface 542. In a networked environment, program modules depicted relative to the computer 502, or portions thereof, can be stored in the remote memory/storage device 550. It will be appreciated that the network connections shown are exemplary and other means of establishing a communications link between the computers can be used.

The computer 502 is operable to communicate with any wireless devices or entities operatively disposed in wireless communication, for example, a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, for example, computers, to send and receive data indoors and out; anywhere within the range of a base station. Wi-Fi networks use radio technologies called IEEE 802.11x (a, b, g, etc.) to provide secure, reliable, fast wireless connectivity. A Wi-Fi network can be used to connect computers to each other, to the Internet, and to wired networks (which use IEEE 802.3 or Ethernet).

Wi-Fi networks can operate in the unlicensed 2.4 and 5 GHz radio bands. IEEE 802.11 applies to generally to wireless LANs and provides 1 or 2 Mbps transmission in the 2.4 GHz band using either frequency hopping spread spectrum (FHSS) or direct sequence spread spectrum (DSSS). IEEE 802.11a is an extension to IEEE 802.11 that applies to wireless LANs and provides up to 54 Mbps in the 5 GHz band. IEEE 802.11a uses an orthogonal frequency division multiplexing (OFDM) encoding scheme rather than FHSS or DSSS. IEEE 802.11b (also referred to as 802.11 High Rate DSSS or Wi-Fi) is an extension to 802.11 that applies to wireless LANs and provides 11 Mbps transmission (with a fallback to 5.5, 2 and 1 Mbps) in the 2.4 GHz band. IEEE 802.11g applies to wireless LANs and provides 20+ Mbps in the 2.4 GHz band. Products can contain more than one band (e.g., dual band), so the networks can provide real-world performance similar to the basic 10 BaseT wired Ethernet networks used in many offices.

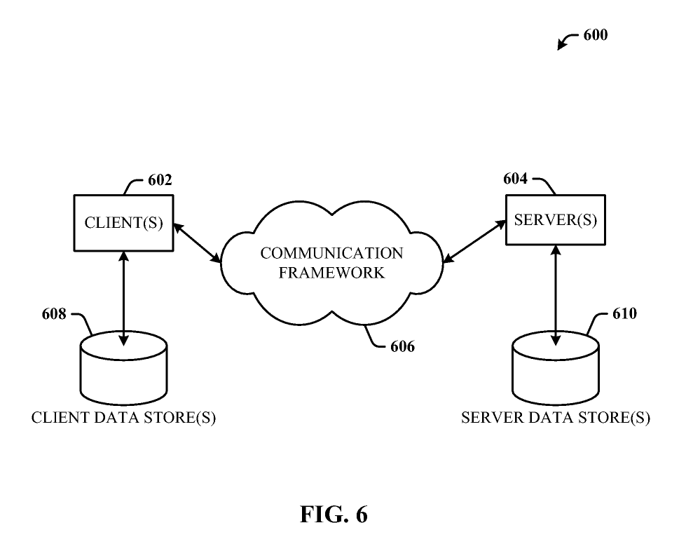

Referring now to FIG. 6, there is illustrated a schematic block diagram of an exemplary computing environment 600 that facilitates communication with an auxiliary device. The environment 600 includes one or more client(s) 602. The client(s) 602 can be hardware and/or software (e.g., threads, processes, computing devices). The client(s) 602 can house cookie(s) and/or associated contextual information, for example.

The environment 600 also includes one or more server(s) 604. The server(s) 604 can also be hardware and/or software (e.g., threads, processes, computing devices). The servers 604 can house threads to perform transformations by employing the architecture, for example. One possible communication between a client 602 and a server 604 can be in the form of a data packet adapted to be transmitted between two or more computer processes. The data packet may include a cookie and/or associated contextual information, for example. The environment 600 includes a communication framework 606 (e.g., a global communication network such as the Internet) that can be employed to facilitate communications between the client(s) 602 and the server(s) 604.

Communications can be facilitated via a wired (including optical fiber) and/or wireless technology. The client(s) 602 are operatively connected to one or more client data store(s) 608 that can be employed to store information local to the client(s) 602 (e.g., cookie(s) and/or associated contextual information). Similarly, the server(s) 604 are operatively connected to one or more server data store(s) 610 that can be employed to store information local to the servers 604.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A computer-implemented auxiliary device system, comprising:
an auxiliary device comprising:
an input component that receives semantic content from a computer system; and,
an output component that provides information to a user in a non-textual manner based on the semantic content.

2. The system of claim 1, wherein the output component provides information to the user aurally.

3. The system of claim 1, wherein the output component provides information to the user as a speech pattern.

4. The system of claim 1, wherein the output component provides information to the user visually.

5. The system of claim 4, wherein the output component provides information to the user by at least one of a glowing color, a blinking frequency of a light, a blinking pattern of a light, a blinking light with a varying frequency or duty cycle, a light blinking with an encoded pattern or a light.

6. The system of claim 1, wherein the output component provides information to the user tactilely.

7. The system of claim 6, wherein the output component provides information to the user by at least one of a frequency vibration, an inaudible mechanical vibration, a pin-like array pattern, a Braille raised dots pattern, an exerted variable force, an electrical stimulus, a static electrical charge, an inflating of a balloon, an inflating of a bladder, a liquid filling a vessel, a liquid being expelled from a vessel by gas pressure or a temperature.

8. The system of claim 1, wherein the output component provides information to the user olfactorily.

9. The system of claim 1, wherein the auxiliary device further includes a format component that formats the semantic content for the output component.

10. The system of claim 9, wherein the format component that receives user control, navigation or content information, formats that information into semantic content and provides the translated semantic content to the computer system.

11. The system of claim 1, wherein the auxiliary device provides information to the computer system based on at least one of a user navigation event or external data collected by the auxiliary device.

12. The system of claim 1, further comprising a computer system comprising a specialized application that provides data from the computer system to the auxiliary device, and, a platform component that communicates the data from the specialized application to the auxiliary device.

13. The system of claim 12, wherein the platform component communicates with the auxiliary device in a device-specific manner.

14. The system of claim 12, wherein the platform component communicates with the auxiliary device in a device-independent manner.

15. A computer-implemented method of communicating with an auxiliary device, comprising:
receiving information to be provided to the auxiliary device;
formatting the information based on non-textual communication capabilities of the auxiliary device; and,
providing the formatted information to the auxiliary device.

16. The method of claim 15, wherein the non-textual communication capabilities of the auxiliary device are at least one of aural, vocal, visual, tactile or olfactory.

17. The method of claim 15, wherein the formatted information is different than information displayed on a primary display.

18. A computer-implemented method of providing non-textual information to a user, comprising:
receiving information from a platform component;
formatting the information based on non-textual communication capabilities of an auxiliary device;
providing the formatting information.

19. The method of claim 18, wherein the non-textual communication capabilities of the auxiliary device are at least one of aural, vocal, visual, tactile or olfactory.

20. The method of claim 18, further comprising providing the formatted information to an additional device.
